(19) United States
(12) Patent Application Publication
(10) Pub. No.: US 2021/0082147 A1
(43) Pub. Date: Mar. 18, 2021

(54) A Method for Validating Sensor Units in a UAV, and a UAV

(71) Applicant: Everdrone AB, Säve (SE)

(72) Inventor: Maciek Drejak, Västra Frölunda (SE)

(21) Appl. No.: 16/772,302

(22) PCT Filed: Dec. 18, 2018
(86) PCT No.: PCT/EP2018/085452

§ 371 Date: Jun. 12, 2020

(30) Foreign Application Priority Data
Dec. 21, 2017 (EP) 17209333.8

(51) Int. Cl. G06T 7/80; G06T 7/13; G06T 7/00; G06T 3/40; B64C 39/02

(52) U.S. Cl. CPC G06T 7/80; G06T 7/13; G06T 7/97; B64C 2201/123; B64C 39/024; B64C 2201/127; G06T 3/4038

(57) ABSTRACT

The present invention relates to a method for validating sensor units in a UAV. The UAV comprising: a first sensor unit and a second sensor unit, each sensor unit being configured to create an image of the surroundings. The method comprising the steps of: taking a first image by the first sensor unit, taking a second image by the second sensor unit, wherein the second image and the first image at least partly overlap, and comparing the overlapping portions between the first image and the second image. Based on a result in which the overlapping portions of the first image and the second image do not correlate to each other, it is determined that at least one of the first sensor unit and the second sensor unit is dysfunctional.

### FIELD OF THE INVENTION

The present invention relates to a method for validating sensor units in a UAV. It also relates to a UAV comprising a first sensor unit and a second sensor unit, as well as use of such sensor units to carry out the validation.

### BACKGROUND OF THE INVENTION

Unmanned aerial vehicles (UAV), also known as drones, are aircrafts without a human pilot aboard the vehicle. There are several different types and sizes of UAVs, and they may be used in a number of different application areas. For example, UAVs may be used to deliver different types of goods, such as products that have been purchased online or medical equipment, e.g. defibrillators, to the scene of an accident. Other areas of use are also possible, such as surveillance and photography.

When using UAVs, especially in urban environments, safety is essential. If the UAV would crash or fail in navigating correctly over a crowded area, both property and humans may be endangered. Therefore, it is crucial that the UAVs do not fail during flight. UAVs typically comprise a number of different sensors to ensure a safe flight and to navigate. One way of minimising the risk of the UAV failing during flight is to validate that the sensors work properly, before initiating a mission. There is therefore a need for an easy and quick way of performing such a validation.

### SUMMARY OF THE INVENTION

It is an object of the present invention to provide a method for validating the sensor units of a UAV which is easy to perform, and which may be used to determine if it is safe to fly the UAV. This and other objects, which will become apparent in the following, are accomplished by a method for validating sensor units in a UAV, a UAV comprising a first sensor unit and a second sensor unit, and use of a first sensor unit and a second sensor unit comprised by a UAV, as defined in the accompanying independent claims.

The term exemplary should in this application be understood as serving as an example, instance or illustration.

The present invention is at least partly based on the realisation that by comparing images acquired by two different sensors or sensor units, which images at least partly overlap, it may be determined that at least one of the sensors or sensor units is dysfunctional if the overlapping portions of the images do not correlate to each other. It is then possible to determine that the UAV is not safe to fly, based on at least one of the sensors or sensor units being dysfunctional.

According to a first aspect of the present invention, a method for validating sensor units in a UAV is provided. The UAV comprises: a first sensor unit and a second sensor unit, each sensor unit being configured to create an image of the surroundings. The method comprises the steps of:
taking a first image by said first sensor unit,
taking a second image by said second sensor unit, wherein said second image and said first image at least partly overlap,
comparing the overlapping portions between the first image and the second image, and based on a result in which said overlapping portions of said first image and said second image do not correlate to each other, determine that at least one of said first sensor unit and said second sensor unit is dysfunctional.

By validating sensor units in a UAV is meant that the functionality of the sensor units is validated. In other words, it is validated if the sensor units work as intended, or if they are dysfunctional.

By sensor unit is meant a unit comprising at least one sensor. Each sensor unit may comprise only one sensor, or it may comprise two or more sensors. Thus, for embodiments in which the sensor unit only comprises one sensor, the senor unit may be referred to as a sensor. The first sensor unit and the second sensor unit may both be part of a sensor arrangement comprising a plurality of sensors. Alternatively, or additionally, the first and/or second sensor unit may correspond to a sensor arrangement comprising a plurality of sensors. The sensor(s) comprised by the first and second sensor unit may suitably be at least one of an RGB camera, an IR camera, a radar receiver or a hyperspectral camera. Other types of sensors are also conceivable and may be used as a complement to any of the above sensor types, such as ultrasound sensors.

The images created by each one of the first and second sensor units may be different types of images. For example, the images may be RGB images, 3D-images, stereo images, depth images, etc. By image is meant a data set or a data matrix, which may be presented visually. However, when comparing the first and the second images, it does not have to be a visual comparison. The comparison may be performed on the two data sets or data matrixes which constitute the first and the second images.

By “at least partly overlap” is meant that at least a portion of the data set or data matrix which constitutes the first image originates from the same physical area of the surroundings as a portion of the data set or data matrix which constitutes the second image. This way, it may be assumed that if both the first sensor unit and the second sensor unit are functioning as desired, the overlapping portions of the first image and the second image should show substantially the same image, i.e. have similar values in the data set/matrix. This is what is meant with the first and the second image correlating to each other. Stated differently, when the overlapping portions of the first and the second image do not correlate to each other, the overlapping portion of the first image does not correspond to the overlapping portion of the second image.

By correspond to and correlate to is not meant that each one of the pixels of the overlapping portions of the first image have to be identical to the pixels of the overlapping portions of the second image. When determining that at least one of said first sensor unit and said second sensor unit is dysfunctional, there may be some tolerance in the correlation. Small variations caused by e.g. a fly passing by one of the sensor units when taking one of the images may not be interpreted as a dysfunctional sensor. In order for this not to happen, “correlate to” may be interpreted as that at least 50%, or at least 60%, or at least 70%, or at least 80% of the corresponding pixels or segments in the overlapping portions of the first image and the second image respectively should correlate to each other, i.e. have similar values. By similar values is meant that the difference between the values is less than 30%, or less than 20%, or less than 10%. By segments in the overlapping portions is meant a collection of pixels, e.g. 4×4 pixels that are merged together and averaged. This may be done in order to reduce noise in the images.

Thus, for example, a first average pixel value for a first segment, being e.g. comprised of a first image matrix of 4×4 pixels in the first image, may be compared to a second average pixel value for a second segment, being e.g. comprised of a second image matrix of 4×4 pixels. If the first average pixel value is similar, or the same, as the second average pixel value, the first segment correlates, or corresponds, to the second segment (that is, e.g. by that the first average pixel value does not differ more than 10%, or more than 20% or more than 30% of the second average pixel value). Hence, for at least the first segment and the second segment, the first and the second sensor units give similar, or corresponding, results. The procedure of comparing the first image with the second image continues with comparing other pixels, or other segments in a similar manner, until correlation of the overlapping portions can be established, or until a non correlation of the overlapping portions can be established. That is, until at least 50%, or at least 60%, or at least 70%, or at least 80% of the corresponding pixels or segments in the overlapping portions of the first image and the second image correlate to each other.

According to at least one example embodiment, the boundaries for the overlapping portions of the first image and the second image are determined by comparing marks, such as landmarks or other significant reference marks in the first and second images. Hereby, a relatively straightforward way to determine the overlapping portions is provided. Subsequently, the pixels or segments of the first and the second image of the determined overlapping portions can be compared as discussed above.

According to at least one example embodiment, the step of comparing the overlapping portions between the first image or the second image is carried out by e.g. comparing histograms (i.e. comparing colours or light of different segments or sub-portions of the images), template matching (i.e. comparing image parts such as e.g. segments or pixels), or feature matching (i.e. extracting a set number of features from one image, and searching for the same features in the compared image). Other methodologies of image comparison know to the skilled person can be used, or be combined with those already described.

The comparison between the first image and the second image may in some embodiments be performed by a control unit comprised by the UAV. In other embodiments, the images may be wirelessly sent to an external control unit, which may perform the comparison.

According to at least one exemplary embodiment of the first aspect of the present invention, in an airborne state, said first sensor unit is in a first position, and wherein the first image is taken in said first position. The method further comprises arranging said UAV such that said second sensor unit is positioned in said first position, wherein the second image is taken when said second sensor unit is in said first position. The advantage of this is that by taking both the first image and the second image when said first sensor unit and said second sensor unit respectively are in said first position, the images do not need to be processed by e.g. angle correction before they are compared. Further, the area of the overlapping portions of the first image and the second image may be larger if the images are taken from the same position, which increases the chance of correctly determining if any one of the sensor units is dysfunctional. The step of arranging the UAV such that the second sensor unit is positioned in said first position may for example comprise rotating the UAV, translating the UAV horizontally and/or translating the UAV vertically.

It should be noted that when arranging said second sensor unit to be positioned in said first position, an exact reproduction of the first position in which the first sensor unit took the first image is not needed. In fact, the UAV will typically vibrate, and may be somewhat tilted between the steps of taking the first image by the first sensor unit in said first position and taking the second image by the second sensor unit in said first position. For example, the first position may be referred to as a first set position indicating that the UAV is set to arrange the UAV in said first position, i.e. the same set position when taking the first image by the first sensor unit and taking the second image by the second sensor unit. The first position when taking the first image by the first sensor unit and the first position when taking the second image by the second sensor unit may for example vary in each of, or one of, the x, y and z-directions in a three-dimensional Cartesian coordinate system by 0 m-0.5 m, e.g. 0 m-0.2 m.

According to at least one exemplary embodiment of the first aspect of the present invention, the method further comprises a step of processing at least one of said first image and said second image before comparing the overlapping portions. This processing may for example comprise angle correction, which may be necessary e.g. if the first image and the second image are not taken from the same position of the respective sensor units, or if the UAV is tilted differently when taking the first and the second images. If two unprocessed images are compared, which images are taken from a first position of the first sensor unit, and from a second position of the second sensor unit, the images may not correlate although the sensor units may be functional. Therefore, it may be advantageous to perform some type of processing, i.e. image processing or processing of the data, before comparing the first image and the second image. Other types of processing may for example include noise reduction, e.g. by averaging and merging pixels as described above, or any other type of noise reduction.

According to at least one exemplary embodiment of the first aspect of the present invention, the UAV further comprises a third sensor unit. The method further comprises:
taking a third image by said third sensor unit, wherein said third image at least partly overlaps with the overlapping portions of said first image and said second image,
performing said comparison also with said third image, and based on a result in which said overlapping portions of said first image, said second image and said third image do not correlate to each other, determine which one of said sensor units that is dysfunctional.

The third sensor unit may have any of the features described in relation to the first sensor unit and the second sensor unit. The third image may accordingly have the same features as described in relation to the first image and the second image. When comparing the first image, the second image, and the third image, it may be determined that at least one of the sensor units is dysfunctional. If for example the overlapping portions of the first image and the second image correlates to each other, but the third image does not correlate to the other two, it may be determined that the third sensor unit is dysfunctional. If however none of the overlapping portions of the first image, the second image and the third image correlates to one of the other images, it may be determined that at least two of the sensor units are dysfunctional, but not which two.

The advantage of having a third sensor unit and performing the comparison also with a third image is that it may be determined which one of the sensor units is dysfunctional, instead of only determining that one of them is dysfunctional. This may simplify the process of repairing the UAV.

According to at least one exemplary embodiment of the first aspect of the present invention, said first sensor unit and said second sensor unit are angularly offset in relation to each other. This may be beneficial to ensure that the UAV can navigate properly in all directions around the circumferential extension of the UAV.

According to at least one exemplary embodiment of the first aspect of the present invention, the method further comprises a step of directly landing the UAV when at least one of said first sensor unit and said second sensor unit is determined to be dysfunctional. By directly landing is meant that the UAV does not perform the flight that was originally planned for it, but lands as soon as safely possible. This is advantageous since performing the originally planned flight with at least one dysfunctional sensor may cause the UAV to fail to perform a safe flight, which may endanger the surrounding environment or damage the UAV.

According to at least one exemplary embodiment of the first aspect of the present invention, the method further comprises a step of launching the UAV to an airborne state, wherein the UAV is hovering when performing the steps of taking said first image and taking said second image. By hovering is meant that in a three-dimensional Cartesian coordinate system, the coordinates of the UAV do not change significantly while performing the steps of taking said first image and taking said second image. Particularly the Z-coordinate, corresponding to the height above the ground, does not change significantly during these steps. This is beneficial since it may be easier to obtain two images with overlapping portions if the UAV is not moving while the images are being taken. It should be understood that the UAV may still move between the steps of taking the first image and taking the second image.

According to at least one exemplary embodiment of the first aspect of the present invention, said first sensor unit and said second sensor unit each comprises at least two sensors. The at least two sensors may be physically separated or be part of two sensor subunits, or they may be arranged on the same physical component. The at least two sensors may in some embodiments be used to create an image having depth information, such as e.g. a stereo image or a 3D image. In such an embodiment, the stereo image or 3D image may be used for the comparison, or the images from the at least two sensors may be compared separately. An advantage of each one of the sensor units comprising at least two sensors is that stereo images or 3D images may be created, using e.g. two RGB cameras or two IR cameras, possibly with an IR projector.

According to at least one exemplary embodiment of the first aspect of the present invention, any one of said two sensors is one of: an RGB camera, an IR camera, a radar receiver or a hyperspectral camera. Other types of sensors are also conceivable and may be used as a complement to any of the above sensor types, such as ultrasound sensors. These sensor types are beneficial since they are able to produce images of the surroundings of the UAV, which is useful for navigating the UAV.

According to a second aspect of the present invention, a UAV is provided. The UAV comprises:

a first sensor unit and a second sensor unit, each sensor unit being configured to create an image of the surroundings,

a control unit configured to:
instruct the first sensor unit to take a first image,
instruct the second sensor unit to take a second image, wherein said second image and said first image at least partly overlap,
compare the overlapping portions between the first image and the second image, and based on a result in which said overlapping portions of said first image and said second image do not correlate to each other, determine that at least one of said first sensor unit and said second sensor unit is dysfunctional.

The instructions may be sent to the first sensor unit and the second sensor unit wirelessly, or the first sensor unit and the second sensor unit may be wired to the control unit.

Effects and features of this second aspect of the present invention are largely analogous to those described above in connection with the first aspect of the inventive concept. Embodiments mentioned in relation to the first aspect of the present invention are largely compatible with the second aspect of the invention, of which some embodiments are explicitly mentioned in the following. In other words, a method for validating sensor units in a UAV as described with any of the embodiments of the first aspect of the invention is applicable to, or may make use of, the UAV described in relation to the second aspect of the invention.

According to at least one exemplary embodiment of the second aspect of the present invention, the UAV further comprises a third sensor unit, and wherein the control unit is further configured to:
instruct the third sensor unit to take a third image, wherein said third image at least partly overlaps with the overlapping portions of said first image and said second image,
perform said comparison also with said third image, and based on a result in which said overlapping portions of said first image, said second image and said third image do not correlate to each other, determine which one of said sensor units is dysfunctional.

As previously described, an advantage of having a third sensor unit and performing the comparison also with a third image is that it may be determined which one of the sensor units is dysfunctional, instead of only determining that one of them is dysfunctional.

According to at least one exemplary embodiment of the second aspect of the present invention, said first sensor unit and said second sensor unit are angularly offset in relation to each other. As previously described, this may be beneficial to ensure that the UAV can perform a safe flight by navigating properly and detecting and avoiding objects approaching the UAV from any direction.

According to at least one exemplary embodiment of the second aspect of the present invention, said control unit is further configured to instruct the UAV to launch to an airborne state, and to hover while taking the first image and while taking the second image. This is beneficial since it may be easier to obtain two images with overlapping portions if the UAV is not moving while the images are being taken. It should be understood that the UAV may still move between the steps of taking the first image and taking the second image, as previously described.

According to a third aspect of the present invention, use of a first sensor unit and a second sensor unit comprised by a UAV, to carry out validation of said sensor units, is provided. This is done by
taking a first image by said first sensor unit,
taking a second image by said second sensor unit, wherein said second image and said first image at least partly overlap,
comparing the overlapping portions between the first image and the second image, and based on a result in which said overlapping portions of said first image and said second image do not correlate to each other, determine that at least one of said first sensor unit and said second sensor unit is dysfunctional.

Effects and features of this third aspect of the present invention are largely analogous to those described above in connection with the first and second aspects of the inventive concept. Embodiments mentioned in relation to the first and second aspects of the present invention are largely compatible with the third aspect of the invention.

### BRIEF DESCRIPTION OF THE DRAWINGS

These and other features and advantages of the present invention will in the following be further clarified and described in more detail, with reference to the appended drawings showing exemplary embodiments of the present invention.

FIG. 1a is a perspective view showing an exemplary embodiment of a UAV according to the present invention.

FIG. 1b is a perspective view showing an exemplary embodiment of a sensor unit comprised by the UAV illustrated in FIG. 1a.

FIG. 2a-e is a schematic illustration of an exemplary embodiment of a method for validating sensor units in a UAV according to the present invention.

FIG. 3 is a flow chart of an exemplary embodiment of a method for validating sensor units in a UAV according to the present invention.

### DETAILED DESCRIPTION OF EMBODIMENTS

In the following detailed description, some embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

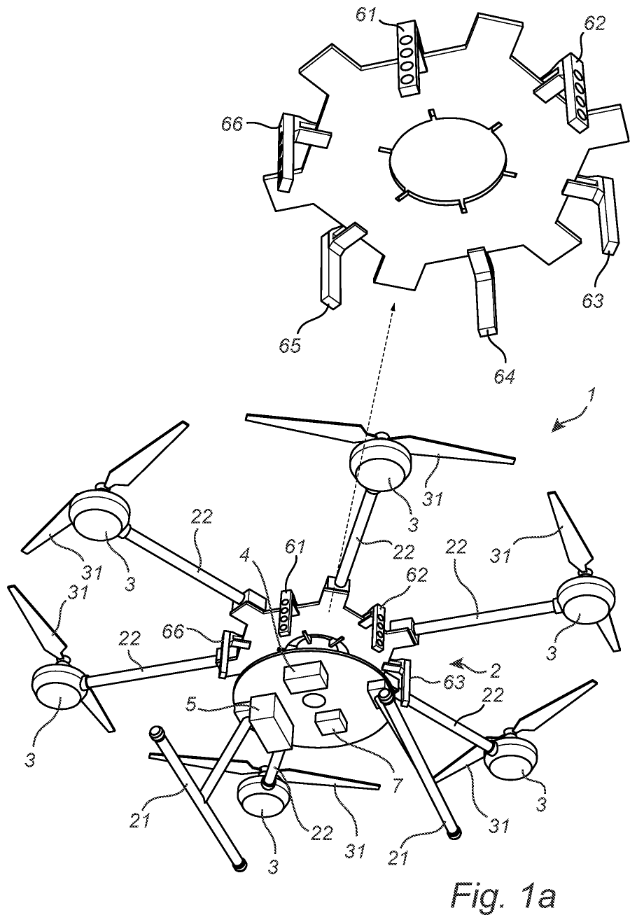

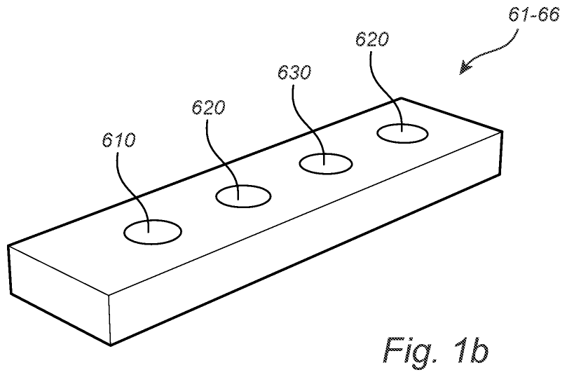

FIG. 1a illustrates a perspective view of an exemplary embodiment of a UAV according to the second aspect of the present invention. The illustrated UAV 1 may be used to perform a method according to the first aspect of the present invention.

The UAV 1 comprises a body 2 having two leg portions 21. The body 2 is adapted to carry all of the other components comprised by the UAV 1, and the leg portions 21 are adapted to support the UAV 1 when it is not being airborne. The UAV 1 further comprises six actuators 3 arranged on six arm portions 22 extending from the body 2. The actuators 3 are connected to six propellers 31. The actuators 3 may suitably be electrical engines or combustion engines. By controlling the actuators 3, the rotation of the propellers 31 and hence the movement of the UAV 1 may be controlled. This is preferably done by a control unit 4. The control unit 4 may be connected to the actuators 3 wirelessly, or they may be wired. The control unit 4 will be further described below.

The actuators 3 and the control unit 4 are powered by a power supply unit 5, which may suitably be some type of battery, e.g. a lithium-polymer battery, or an electrical generator of some type. The power supply unit 5 may comprise a plurality of subunits, e.g. a plurality of batteries. The size and capacity of the power supply unit 5 may be adapted to the size/weight of the UAV 1, the size/weight of potential goods that the UAV 1 is to carry, and the length of the flights that the UAV 1 is intended to perform. In some embodiments, the power supply unit may not be a part of the UAV, but the UAV may be connected to an external power supply unit, e.g. by wiring the UAV to the mains electricity.

The UAV 1 further comprises a first sensor unit 61 and a second sensor unit 62 which is angularly offset in relation to each other. In this exemplary embodiment, the UAV 1 further comprises a third sensor unit 63, a fourth sensor unit 64, a fifth sensor unit 65, and a sixth sensor unit 66 angularly offset in relation to each other. Each one of the sensor units is configured to create an image of the surroundings. All of the sensor units are mounted circumferentially of the UAV, angularly offset in relation to each other. In some embodiments, a seventh sensor unit may be mounted at the centre of the UAV, facing downwards. Although only the first sensor unit 61, the second sensor unit 62 and the third sensor unit 63 are described in the following detailed description, any features and method steps described in relation to the first, second and third sensor units 61, 62, 63 may also be applied to the fourth, fifth and sixth sensor units 64, 65, 66. The sensor units 61-66 will be further described in relation to FIG. 1b.

The UAV 1 further comprises a control unit 4. The control unit 4 may for example be manifested as a general-purpose processor, an application specific processor, a circuit containing processing components, a group of distributed processing components, a group of distributed computers configured for processing, a field programmable gate array (FPGA), etc. The control unit 4 may further include a microprocessor, microcontroller, programmable digital signal processor or another programmable device. The control unit 4 may also, or instead, include an application specific integrated circuit, a programmable gate array or programmable array logic, a programmable logic device, or a digital signal processor. Where the control unit 4 includes a programmable device such as the microprocessor, microcontroller or programmable digital signal processor mentioned above, the processor may further include computer executable code that controls operation of the programmable device.

The UAV 1 according to the illustrated exemplary embodiment further comprises a GPS module 7, for navigation of the UAV 1. Other embodiments may not comprise a GPS module, or may comprise a GPS module but may not use it for navigation. In this exemplary embodiment however, correspondingly to the control unit 4, the GPS module 7 may for example include a GPS receiver, a microprocessor, microcontroller, programmable digital signal processor or another programmable device. The GPS module 7 may also, or instead, include an application specific integrated circuit, a programmable gate array or programmable array logic, a programmable logic device, or a digital signal processor arranged and configured for digital communication with the control unit 4. Where the control unit 4 includes a programmable device such as the microprocessor, microcontroller or programmable digital signal processor mentioned above, the GPS module 7 may simply comprise a GPS receiver and circuits for digital communication with the control unit 4.

The processor (of the control unit 4 and/or the GPS module 7) may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

The control unit 4 is connected to the various described features of the UAV 1, such as e.g. the GPS module 7, the sensor units 61-66 and the actuators 3, and is configured to control system parameters. Moreover, the control unit 4 may be embodied by one or more control units, where each control unit may be either a general purpose control unit or a dedicated control unit for performing a specific function.

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special purpose computer, or special purpose processing machines to perform a certain function or group of functions.

It should be understood that the control unit 4 may comprise a digital signal processor arranged and configured for digital communication with an off-site server or cloud based server. Thus data may be sent to and from the control unit 4.

FIG. 1b illustrates a perspective view of an exemplary sensor unit 61-66 comprised by the UAV 1 illustrated in FIG. 1a. This exemplary sensor unit 61-66 comprises two different types of sensors: an RGB camera 610 and two IR cameras 620. It further comprises an IR laser projector 630. By combining two images obtained by the two IR cameras 620 it is possible to extract depth information from the image, i.e. to create a depth image. The IR laser projector 630 may be used to further illuminate the scene in order to enable extraction of depth information in any lighting condition and surface textures. The depth image may if desired be combined with an RGB image acquired by the RGB camera 610, to create a stereo image or a 3D image. When performing the comparison of a first and a second image according to the present invention, using the described exemplary sensor units 61-66, this may include comparing a first and a second depth image, a first and a second IR image, a first and a second RGB image, a first and a second 3D image and/or a first and a second stereo image.

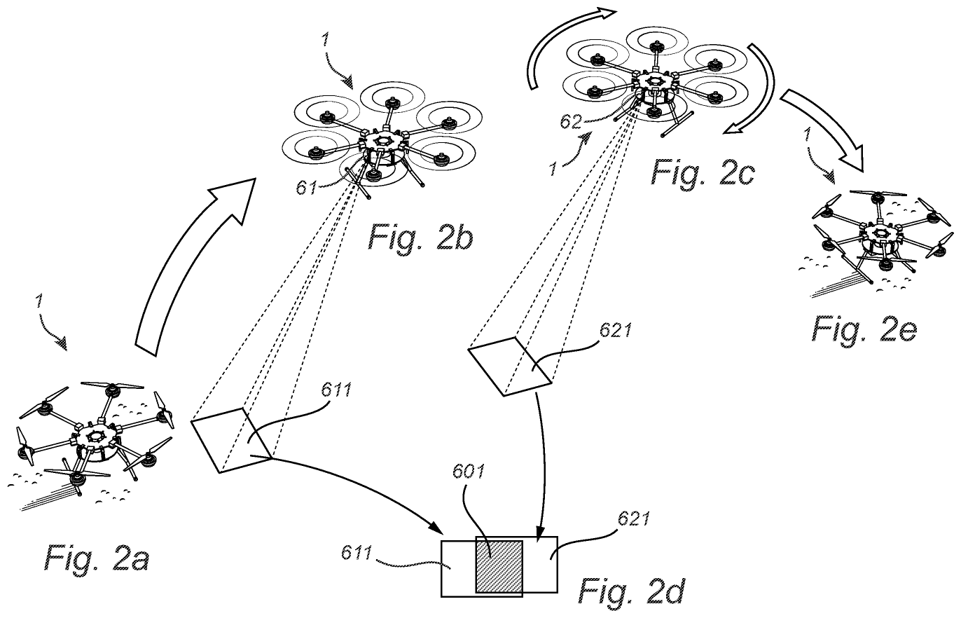

In FIG. 2a-e, an exemplary embodiment of a method for validating sensor units 61-66 in a UAV 1 according to the present invention is schematically illustrated. In this embodiment, the UAV 1 starts from the ground in FIG. 2a. When receiving instructions to perform a validation, the UAV 1 is launched to an airborne state illustrated in FIG. 2b. This is achieved by the control unit 4 instructing to UAV 1, i.e. the actuators 3, such that the propellers 31 are activated and the UAV 1 is launched. The UAV 1 is launched to an airborne state, and at a desired height it is instructed by the control unit 4 to hover. While hovering, a first image 611 is taken by said first sensor unit 61 in a first position, as illustrated in FIG. 2b. This is also controlled by the control unit 4. After taking the first image 611, the UAV is arranged such that the second sensor unit 62 is positioned in the first position, see FIG. 2c. In this exemplary embodiment, this is done by rotating the UAV 1. When the second sensor unit 62 is positioned in the first position, the UAV 1 once again hovers, and a second image 621 is taken by said second sensor unit 62. Since the first sensor unit 61 and the second sensor unit 62 were both in the first position while taking the first image 611 and the second image 621, the second image 621 and the first image 611 will at least partly overlap, as is illustrated in FIG. 2d. Using the control unit 4, the overlapping portions 601 between the first image 611 and the second image 621 are compared. If the comparison shows a result in which the overlapping portions 601 of the first image 611 and the second image 621 do not correlate to each other, it is determined that at least one of the first sensor unit 61 and the second sensor unit 62 is dysfunctional. In this exemplary embodiment, the UAV 1 is instructed by the control unit 4 to directly land, see FIG. 2e, if at least one of the first sensor unit 61 and the second sensor unit 62 is determined to be dysfunctional. If it is determined that both the first sensor unit 61 and the second sensor unit 62 are functional, the UAV 1 may not be instructed to land, but may instead perform an intended flight.

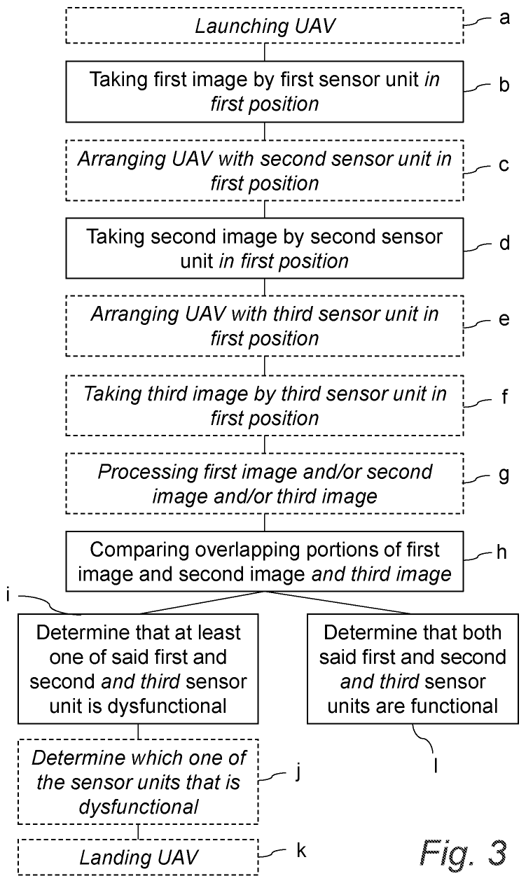

FIG. 3 shows a flow chart of an exemplary embodiment of a method for validating sensor units in a UAV according to the present invention. The steps of the method that are described in italics and surrounded by a dashed frame are optional, i.e. steps a, c, e, f, g, j, k. The portions of steps b, d, h, I and l that are written in italics are also optional. The method will now be described in more detail, including all of the steps a-l.

The process may be initiated by the UAV receiving instructions to perform a validation of the sensor units. These instructions may be given directly, or the control unit may for example be programmed to perform a validation every time the UAV is instructed to initiate a flight. The process may then start with step a, wherein the UAV is launched to an airborne state, similar to what is described in relation to FIG. 2a-2b. Once launched, the UAV may be instructed to hover while taking a first image by the first sensor unit, i.e. during step b. In some embodiments, this may be done with the sensor unit arranged in a first position. In an optional step which may be included in some exemplary embodiments, step c, the UAV is then arranged so that the second sensor unit is in the first position. This may be done as in FIG. 2c, i.e. by rotating the UAV. In other embodiments, it may be achieved by translating the UAV horizontally and/or vertically, depending on how the sensor units are arranged. Following step b or c, a second image is taken by the second sensor unit in step d, such that the second image at least partly overlaps with the first image. If step c has been performed, the second image is taken with the second sensor unit in the first position.

After step d, three optional steps follow. In step e, the UAV may be arranged such that a third sensor unit is in the first position. This is suitably followed by a step f in which a third image is taken by the third sensor unit, in the first position, such that the third image at least partly overlaps with the overlapping portions of the first image and the second image.

All of the steps related to taking images, i.e. steps b, d and f, are suitably performed by the control unit giving instructions to the sensor units to take such images. All of the steps of arranging the UAV are suitably performed by the control unit giving instructions to the actuators which control the propellers of the UAV.

After the first image, the second image, and optionally the third image have been taken, the process may include a step g of processing any one(s) of, or all of the images. The processing step may include any suitable type of image or data processing. This is followed by the step h of comparing the overlapping portions of the first image, the second image and optionally the third image. The comparison is suitably performed by the control unit. Based on a result from the comparison in which the overlapping portions of the first image, the second image and optionally the third image do not correlate to each other, in step i it may be determined that at least one of the sensor units is dysfunctional. If the process includes step f of taking a third image, step i may be followed by a step j of determining which one of the sensor units that is dysfunctional. This may be desired to simplify the process of repairing the UAV.

In some embodiments, the UAV may be instructed by the control unit to land, in step j, if it is determined that at least one of the sensor units is dysfunctional. If instead it is determined in step l that both the first sensor unit and the second sensor unit, and optionally the third sensor unit, are functional, the UAV may be allowed to continue to fly.

Although FIG. 2a-e and FIG. 3 may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the disclosure has been described with reference to specific exemplifying embodiments thereof, many different alterations, modifications and the like will become apparent for those skilled in the art.

The person skilled in the art realizes that the present invention by no means is limited to the embodiments described above. The features of the described embodiments may be combined in different ways, and many modifications and variations are possible within the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements.

1. A method for validating sensor units in a UAV comprising a first sensor unit and a second sensor unit said method comprising:
taking a first image by said first sensor unit;
taking a second image by said second sensor unit, wherein said second image and said first image at least partly overlap; and
comparing overlapping portions between the first image and the second image, and based on a result in which said overlapping portions of said first image and said second image do not correlate to each other, determine that at least one of said first sensor unit and said second sensor unit is dysfunctional.

2. The method according to claim 1, wherein in an airborne state, said first sensor unit is in a first position, and wherein the first image is taken in said first position, said method further comprises:
arranging said UAV such that said second sensor unit is positioned in said first position, wherein the second image is taken when said second sensor unit is in said first position.

3. The method according to claim 1, further comprising:
processing at least one of said first image and said second image before comparing the overlapping portions.

4. The method according to claim 1, wherein the UAV further comprises a third sensor unit, and said method further comprises:
taking a third image by said third sensor unit, wherein said third image at least partly overlaps with the overlapping portions of said first image and said second image,
said comparing also includes said third image, and based on a result in which overlapping portions of said first image, said second image, and said third image do not correlate to each other, determine which of the first sensor unit, the second sensor unit, and the third sensor unit said is dysfunctional.

5. The method according to claim 1, wherein said first sensor unit and said second sensor unit are angularly offset in relation to each other.

6. The method according to claim 1, further comprising:
directly landing the UAV when at least one of said first sensor unit and said second sensor unit is determined to be dysfunctional.

7. The method according to claim 1, further comprising:
launching the UAV to an airborne state, wherein the UAV is hovering when performing the steps of taking said first image and taking said second image.

8. The method according to claim 1, wherein said first sensor unit and said second sensor unit each comprise at least two sensors.

9. The method according to claim 8, wherein any one of said at least two sensors is one of: an RGB camera, an IR camera, a radar receiver, or a hyperspectral camera.

10. A UAV, comprising:
a first sensor unit and a second sensor unit, each of the first sensor unit and the second sensor unit being configured to create an image of surroundings; and
a control unit configured to:
instruct the first sensor unit to take a first image;
instruct the second sensor unit to take a second image, wherein said second image and said first image at least partly overlap; and
compare overlapping portions between the first image and the second image, and based on a result in which said overlapping portions of said first image and said second image do not correlate to each other, determine that at least one of said first sensor unit and said second sensor unit is dysfunctional.

11. The UAV according to claim 10, further comprising a third sensor unit, and wherein the control unit is further configured to:
instruct the third sensor unit to take a third image, wherein said third image at least partly overlaps with the overlapping portions of said first image and said second image,
perform a comparison with said first image, said second image, and said third image, and based on a result in which overlapping portions of said first image, said second image, and said third image do not correlate to each other, determine which of the first sensor unit, the second sensor unit, and the third sensor unit is dysfunctional.

12. The UAV according to claim 10, wherein said first sensor unit and said second sensor unit are angularly offset in relation to each other.

13. The UAV according to claim 10, wherein said control unit is further configured to instruct the UAV to launch to an airborne state, and to hover while taking the first image and while taking the second image.

14. A method of using a first sensor unit and a second sensor unit comprised by a UAV, to carry out validation of said sensor units, the method comprising:
taking a first image by said first sensor unit;
taking a second image by said second sensor unit, wherein said second image and said first image at least partly overlap; and
comparing overlapping portions between the first image and the second image, and based on a result in which said overlapping portions of said first image and said second image do not correlate to each other, determine that at least one of said first sensor unit and said second sensor unit is dysfunctional.

15. The UAV according to claim 10, wherein in an airborne state, said first sensor unit is in a first position, and wherein the first image is taken in said first position, and said control unit is further configured to:
control said second sensor unit to take said second image when said second sensor unit is positioned in said first position.

16. The UAV according to claim 10, wherein said control unit is further configured to:
process at least one of said first image and said second image before comparing the overlapping portions.

17. The UAV according to claim 10, and said control unit is further configured to:
instruct the UAV to land directly when at least one of said first sensor unit and said second sensor unit is determined to be dysfunctional.

18. The UAV according to claim 10, wherein said first sensor unit and said second sensor unit each comprise at least two sensors.

19. The UAV according to claim 18, wherein any one of said at least two sensors is one of: an RGB camera, an IR camera, a radar receiver, or a hyperspectral camera.
